(19) United States
(12) Patent Application Publication
(10) Pub. No.: US 2004/0064367 A1
(43) Pub. Date: Apr. 1, 2004

(54) Method for revenue enhancement of a business establishment

(76) Inventors: W. Ross McKee JR., Alpharetta, GA (US); Thomas Halcom, Ft. Mill, SC (US); Robert Breckenridge, Concord, NC (US)

Correspondence Address: POWELL, GOLDSTEIN, FRAZER, & MURPHY LLP, 16TH FLOOR, 191 PEACHTREE STREET, NE, ATLANTA, GA, 30303-1736, US

(21) Appl. No.: 10/611,169

(22) Filed: Jun. 30, 2003

Related U.S. Application Data
(60) Provisional application No. 60/392,227, filed on Jun. 28, 2002.

(51) Int. Cl. G06F 17/60

(52) U.S. Cl. 705/14

(57) ABSTRACT

The present invention is method for revenue enhancement for a business establishment, comprising the steps of providing a wireless operational aid visible to a prospective patron of the business establishment; displaying a Billboard Page on the operational aid; focusing the content of the Billboard Page towards a selected group of users of the World Wide Web and Delivered Content; offering a selected user from the group of users controllable access to the World Wide Web and Delivered Content via selected Web Pages stored on the operational aid; and receiving selectively configurable revenue from the selected user.

### CROSS REFERENCE TO RELATED APPLICATION

This application claims priority benefit from copending U.S. Provisional Patent Application No. 60/392,227, filed Jun. 28, 2002, entitled, “METHOD FOR REVENUE ENHANCEMENT OF A BUSINESS ESTABLISHMENT”, the disclosure of which is incorporated herein in its entirety.

### BRIEF DESCRIPTION OF THE DRAWINGS

The invention is illustrated in the drawings in which like reference characters designate the same or similar parts throughout the figures of which:

FIG. 1 illustrates a top level block diagram view of the preferred embodiment of the present invention,

FIG. 2 illustrates a top-level block diagram view of an operation aid to the present invention of FIG. 1.

### DETAILED DESCRIPTION

Before describing in detail the particular improved method for revenue enhancement for a business establishment in accordance with the present invention, it should be observed that the invention resides primarily in a novel method of doing business and not in the structural combination of conventional data/signal processing components, associated communication circuits, the command and control of the aforementioned components and circuits, and in the particular detailed configuration thereof. Accordingly, business transactions between a client business establishment, a customer and the owner of a communication device have, for the most part, been illustrated in the drawings by readily understandable block diagram representations and flow charts. The drawings show only those specific details that are pertinent to the present invention in order not to obscure the disclosure with structural details which will be readily apparent to those skilled in the art having the benefit of the description herein. For example, thin-client technology, Data Center technology and wireless communication technology are well known in the art and are applied to the present invention in the form of a Web Based communication device in concert with a Data Center Server.

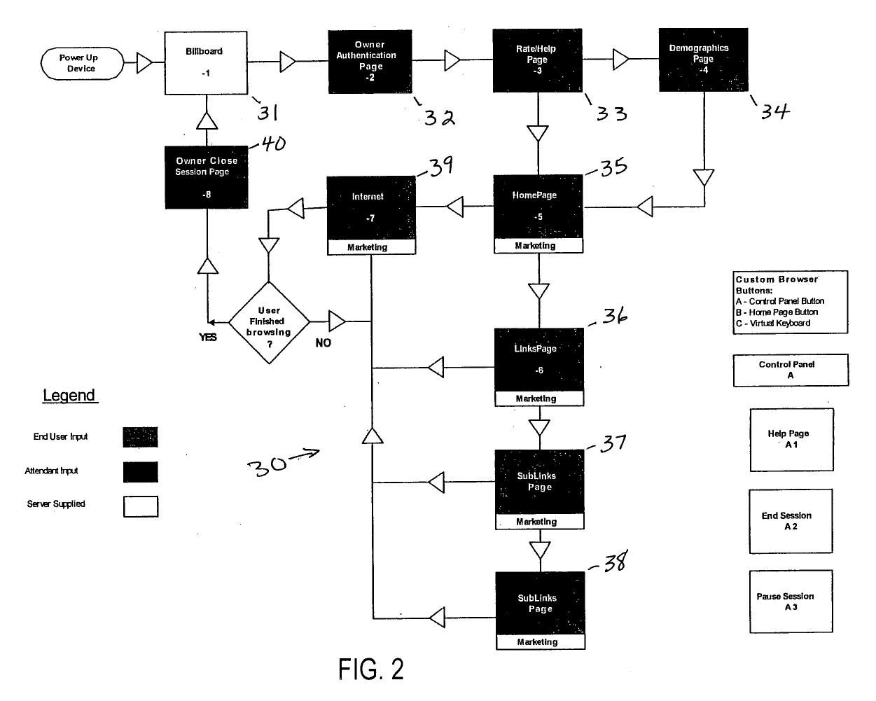

The Web Based communication device or operational aid 30, FIG. 2, may, if desired, have a Billboard Page 31 displayed on an attached display. The Billboard Page 31 displays incentive attractions focused towards selected user interaction. A first user responsive to the incentive attractions requests use of the operational aid 30 from the attendant of the business establishment. The attendant authorizes use of the operational aid 30 via an Owner Authentication Page 32 resident on the operational aid 30. A Rate/Help Page 33 guides the first user through a selection of rates, terms and conditions for the use of the operational aid 30. The “free of cost” option is presented to the first user in exchange for the user's demographics via the Demographics Page 34. Upon completion of the Demographics Page 34 control is passed to the Data Center via the resident Home-Page 35. The Home-Page 35 allows the first user to communicate via Links Page 36, 37 or 38. The first user may, if desired, continue activity for a selected or predetermined time period. After expiration of the selected or predetermined time period the first user returns the operational aid 30 to the attendant for closure via an Owner's Close Session Page 40.

The structure and functionality of the various aforementioned technologies and operational aid have been simplified in order to emphasize those portions that are most pertinent to the invention. Thus, the block diagram and flow chart illustrations of the Figures do not necessarily represent the mechanical structural arrangement of the exemplary system, but are primarily intended to illustrate implementation of the invention.

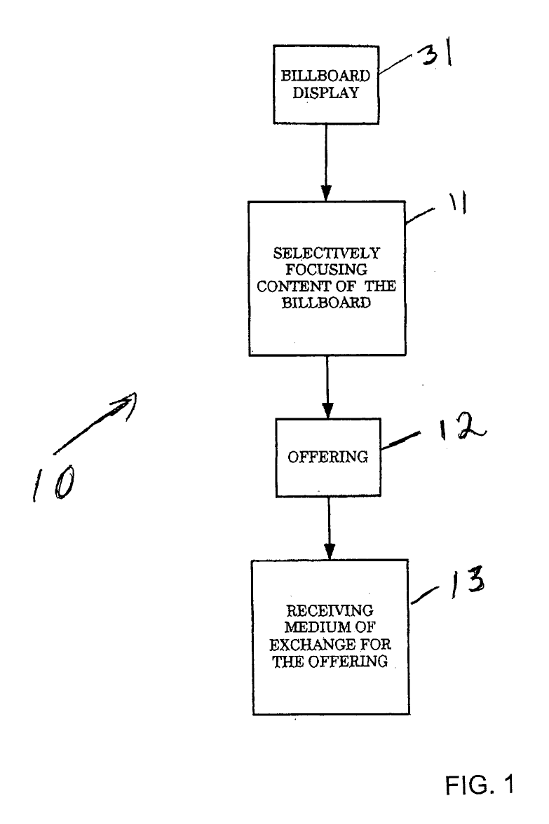

The present invention 10, FIG. 1, is a method of doing business between a customer, a client, and an owner of the operational aid 30. The offer is for free or paid access time to the World Wide Web and/or Delivered Content via the operational aid 30 in exchange for providing selected demographics.

The operational aid 30, FIG. 2, is situated upright in a stand in a high profile location of a client owned retail establishment. The high profile location may, if desired, be supplemented by banner advertisements positioned at selective locations through out the business establishment. The content of the Billboard Page 31 may, if desired, be focused towards selected customers based in part on demographics obtained during the customer's previous use of the operational aid 30. The content on the Billboard Page 31 may be changed or updated by the Data Center. For example, the business establishment may have one type of customer demographics during the daytime and an alternate set of customer demographics during the evening hours of operation. Changes are controlled from the Data Center on a per Device basis. Changes can be affected from the Data Center on the fly, remotely to any location.

An attendant of the establishment trained in the use of the operation aid 30, FIG. 1, and in the establishment's type of business prompts or makes an offer 12 to the customer to see if he would like to “Browse the Internet while he waits.” The attendant generally explains the use of the operational aid 30. If the customer is interested, the attendant activates the operational aid 30 and gives the device to the customer.

The present invention 10, FIG. 1, supports a plurality of “dynamic” Ads (i.e., daily specials, upcoming events, etc.) displayed along with options for free or paid Internet Access. The free Internet access is a predetermined number of minutes in exchange for basic demographic data collected at our Data Center and stored into the Database for extraction and analysis. Once the minutes of “free” Internet time has elapsed, the user is prompted to continue using the Internet for a per minute fee or stop. If he chooses to stop, a message appears asking him to return the device to the attendant. If the user chooses to continue surfing the web, he is prompted with the payment options 13. The customer selects one of the available Rate Plans. These options vary based on the retail chain preferences. The prices vary depending on the geographical location. Some retail chains may want to give the customer the option of paying by the session (e.g., $8 unlimited), or by the minute (e.g., $0.20/minute). Based on demographics and business practices, some clients may choose to offer both options or one option only. The choices of billing options is configurable on a per device basis. The design and number of pages that can be displayed for each device is also configurable and can be changed at any time.

The present invention provides a mobile, wireless device that permits access to the WWW and Delivered Content, where users are not required to provide payment up front through an insecure medium. An “attendant” of the local establishment collects the payment after services are rendered and the customer is satisfied. This is huge departure from the other established forms of Pay-for-Internet models. A subscription-based company charges their clients on a periodic basis regardless of usage. A kiosk based company charges the customer before allowing access to their device. Therefore, the customer must provide payment to an unattended device before using the service.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims, means-plus-function clause is intended to cover the structures described herein as performing the recited function and not only structural equivalents but also equivalent structures. Thus, although a nail and a screw may not be structural equivalents in that a nail employs a cylindrical surface to secure wooden parts together whereas a screw employs a helical surface, in the environment of fastening wooden parts, a nail and a screw may be equivalent structures.

We claim:

1) A method for revenue enhancement for a business establishment, comprising the steps of:
a) providing a wireless operational aid visible to a prospective patron of the business establishment;
b) displaying a Billboard Page on said operational aid;
c) focusing the content of said Billboard Page towards a selected group of users of the World Wide Web and Delivered Content;
d) offering a selected user from said group of users controllable access to the World Wide Web and Delivered Content via selected Web Pages stored on said operational aid; and
e) receiving selectively configurable revenue from said selected user.

2) A method for revenue enhancement of a business establishment as recited in claim 1 further comprising the step of collecting said selected user demographics.

3) A method for revenue enhancement of a business establishment as recited in claim 1 further comprising the step of exchanging access to the World Wide Web for providing selected demographics.

4) A method for revenue enhancement of a business establishment as recited in claim 1 further comprising the step of displaying selected revenue enhancing banners via said operational aid to selected users.
